(19) United States
(12) Patent Application Publication
(10) Pub. No.: US 2002/0064592 A1
(43) Pub. Date: May 30, 2002

(54) Electroless method of seed layer depostion, repair, and fabrication of Cu interconnects

(76) Inventors: Madhav Datta, Portland, OR (US); Valery M. Dubin, Portland, OR (US); Christopher D. Thomas, Aloha, OR (US); Paul J. McGregor, Hillsboro, OR (US)

Correspondence Address: Raymond J. Werner, BLAKELY, SOKOLOFF, TAYLOR & ZAFMAN, LLP, 7th Floor, 12400 Wilshire Boulevard, Los Angeles, CA, 90025, US

(21) Appl. No.: 09/728,683

(22) Filed: Nov. 29, 2000

(51) Int. Cl. B05D 5/12; B05D 1/36; B05D 1/18; B05D 3/10

(52) U.S. Cl. 427/98; 427/123; 427/305; 427/437; 427/443.1; 427/142

(57) ABSTRACT

Electroless deposition of Cu provides for repair of copper seed layers formed by vacuum deposition processes, for formation of copper seed layers on catalytic materials, and for bulk fill of damascene trenches and via openings. Electroless plating baths for such depositions are formulated for both room temperature and elevated temperature operation, and each include a copper source, an environmentally friendly reducing agent, a pH buffer, a complexing agent, and a surfactant.

### BACKGROUND OF THE INVENTION

1. Field of the Invention

The present invention relates generally to the field of metal plating, and more specifically, to electroless plating of copper onto wafers to fill damascene structures in the manufacture of integrated circuits.

2. Background

Advances in semiconductor manufacturing technology have led to the development of integrated circuits having multiple levels of interconnect. In such an integrated circuit, patterned conductive material on one interconnect level is electrically insulated from patterned conductive material on another interconnect level by films of material such as, for example, silicon dioxide. These conductive materials are typically a metal or metal alloy. Connections between the conductive material at the various interconnect levels are made by forming openings in the insulating layers and providing an electrically conductive structure such that the patterned conductive material from different interconnect levels are brought into electrical contact with each other. These electrically conductive structures are often referred to as contacts or vias.

Other advances in semiconductor manufacturing technology, such as the ability to repeatably pattern very small features, have led to the integration of millions of transistors, each capable of switching at high speed. A consequence of incorporating so many fast switching transistors into an integrated circuit is an increase in power consumption during operation. One technique for increasing speed while reducing power consumption is to replace the traditional aluminum and aluminum alloy interconnects found on integrated circuits with a metal such as copper, which offers lower electrical resistance. Those skilled in the electrical arts will appreciate that by reducing resistance, electrical signals may propagate more quickly through the interconnect pathways on an integrated circuit. Furthermore, because the resistance of copper is significantly less than that of aluminum, the cross-sectional area of a copper interconnect line, as compared to an aluminum interconnect line, may be made smaller without incurring increased signal propagation delays based on the resistance of the interconnect. Additionally, because the capacitance between two electrical nodes is a function of the overlap area between those nodes, using a smaller copper interconnect line results in a decrease in parasitic capacitance. In this way, replacing aluminum-based interconnects with copper-based interconnects provides, depending on the dimensions chosen, reduced resistance, reduced capacitance, or both.

As noted above, copper has electrical advantages, such as lower resistance per cross-sectional area, the ability to provide for reduced parasitic capacitance, and greater immunity to electromigration. For all these reasons, manufacturers of integrated circuits find it desirable to include copper in their products.

While advantageous electrically, copper is difficult to integrate into the process of making integrated circuits. As is known in this field, copper can adversely affect the performance of metal oxide semiconductor (MOS) field effect transistors (FETs) if the copper is allowed to migrate, or diffuse, into the transistor areas of an integrated circuit. Therefore copper diffusion barriers are used to isolate copper metal from those transistor areas. Additionally, unlike aluminum-based metal interconnect systems which are formed by subtractive etch processes, copper interconnects are typically formed by damascene metal processes. Such processes are also sometimes referred to as inlaid metal processes. In a damascene process, trenches are formed in a first layer, and a metal layer is formed over the first layer including the trenches. Excess metal is then polished off leaving individual interconnect lines in the trenches.

Accordingly, there is a need for metal plating methods, materials, and apparatus that can form, on wafers, very narrow conductive interconnects made from such materials as copper and copper alloys.

### BRIEF DESCRIPTION OF THE DRAWINGS

FIG. 1 is a schematic cross-sectional view of a copper damascene structure. This structure represents a post-plating, pre-polishing state of fabrication in which a bulk electrolytic deposition has been performed over a layer deposited by an electroless process.

FIG. 2 is a schematic cross-sectional view of a copper damascene structure. This structure represents a post-plating, pre-polishing state of fabrication in which an electroless Cu deposition process has been used to repair a seed layer as well as to perform the bulk fill.

FIG. 3 is a flow diagram of a method in accordance with the present invention.

FIG. 4 is a flow diagram of an alternative method in accordance with the present invention.

FIG. 5 is a flow diagram of a further alternative method in accordance with the present invention.

### DETAILED DESCRIPTION

Methods of electroless copper plating are described. In the following description numerous specific details are set forth to provide an understanding of the present invention. It will be apparent, however, to those skilled in the art and having the benefit of this disclosure, that the present invention may be practiced with apparatus and processes that vary from those specified herein.

Reference herein to “one embodiment”, “an embodiment”, or similar formulations, means that a particular feature, structure, or characteristic described in connection with the embodiment is included in at least one embodiment of the present invention. Thus, the appearances of such phrases or formulations herein are not necessarily all referring to the same embodiment. Furthermore, various particular features, structures, or characteristics may be combined in any suitable manner in one or more embodiments.

Terminology

The terms, chip, integrated circuit, monolithic device, semiconductor device or component, microelectronic device or component, and similar terms and expressions, are often used interchangeably in this field. The present invention is applicable to all the above as they are generally understood in the field.

The terms metal line, trace, wire, conductor, signal path and signaling medium are all related. The related terms listed above, are generally interchangeable, and appear in order from specific to general. In this field, metal lines are sometimes referred to as traces, wires, lines, interconnects or simply metal.

The terms contact and via, both refer to structures for electrical connection of conductors from different interconnect levels. These terms are sometimes used in the art to describe both an opening in an insulator in which the structure will be completed, and the completed structure itself. For purposes of this disclosure, contact and via refer to the completed structure.

The unit grams/liter is abbreviated as g/l.

The term vertical, as used herein, means substantially perpendicular to the surface of a substrate.

As mentioned above, in a damascene process, trenches are formed in a first dielectric layer, a metal layer is formed over the first dielectric layer including the trenches, and excess metal is then polished off leaving individual interconnect lines in the trenches. Damascene metallization processes are referred to as single damascene if only trenches are formed, and dual damascene if trenches and via openings are formed. More particularly, in conventional dual damascene processes, a barrier layer is formed over the surfaces of the dielectric layer, the trenches, and via openings. This barrier layer is formed from one or more materials that are selected for their ability to prevent, or substantially eliminate, the diffusion of copper from an interconnect line into the surrounding dielectric material. A copper seed layer is then formed over the barrier layer, and conventional electroplating of copper is then performed.

Conventional methods of forming Cu seed layers include deposition by a self-ionized plasma (SIP), which is unable to provide a conformal and continuous thin layer on small trenches and vias. By contrast, an electroless method of forming Cu seed layers in accordance with the present invention can be used for deposition of a continuous and conformal thin Cu seed layer which is essential to obtaining void-free electroplated Cu interconnects. In one embodiment of the invention, a Co layer, which is used as a catalytic surface, also acts as a shunt layer providing improved electromigration properties for Cu interconnects.

An electroless process in accordance with the invention can be used for repairing SIP deposited Cu seed layers, and can also be used for fabrication of Cu interconnects.

FIG. 1 is a schematic cross-sectional view of a copper damascene structure 100 formed on a partially processed wafer. Damascene structure 100 represents a post-plating, pre-polishing state of fabrication in which a bulk electrolytic deposition has been performed over a layer deposited by an electroless process. Electrolytic deposition, or electroplating, involved forcing a current between a cathode and an anode. Forcing such a current typically involves applying a voltage to a wafer (the wafer being one electrode in the plating bath) such that there copper may be reduced by gaining electrons from the wafer. More particularly, an ILD 102 is patterned to from a trench therein. As shown in FIG. 1, the vertical sidewall surfaces and bottom surface of the trench, and the top surface of ILD 102 are covered with a barrier layer 104. Barrier layer 104 is formed of a material which substantially or completely prevents the diffusion of copper atoms from a subsequently formed copper or copper-alloy layer. A seed layer 105 is formed over barrier layer 104. Copper and cobalt are examples of metals that may be used to form seed layer 105. An electroless deposition of copper is then performed. A layer 106 of electroless Cu is formed over seed layer 105. Such an operation is beneficial for the morphology of seed layer 105. Deposition of layer 106 is referred to as repairing the seed layer. As further indicated in FIG. 1, a bulk fill copper deposition is performed to complete the trench filling operation. Bulk fill copper 108 covers electroless copper layer 106 both in the trench and over the top surface of ILD 102. In this example, bulk fill copper is formed by an electrolytic deposition.

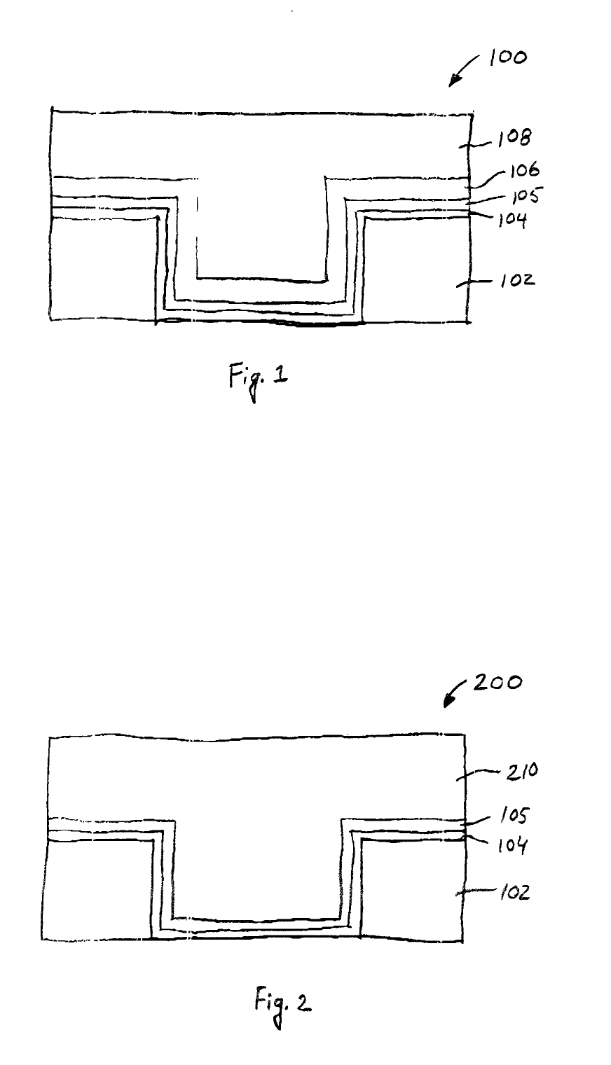

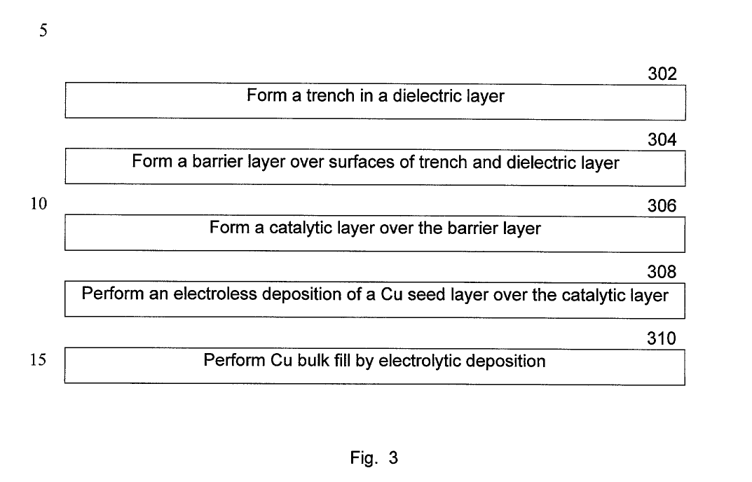

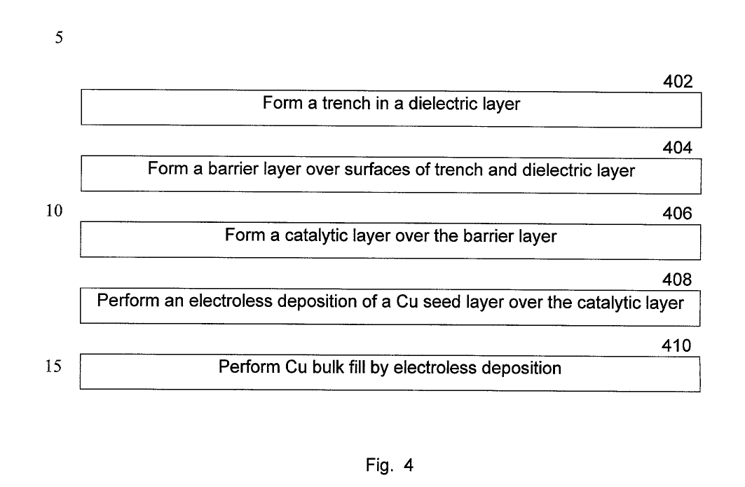

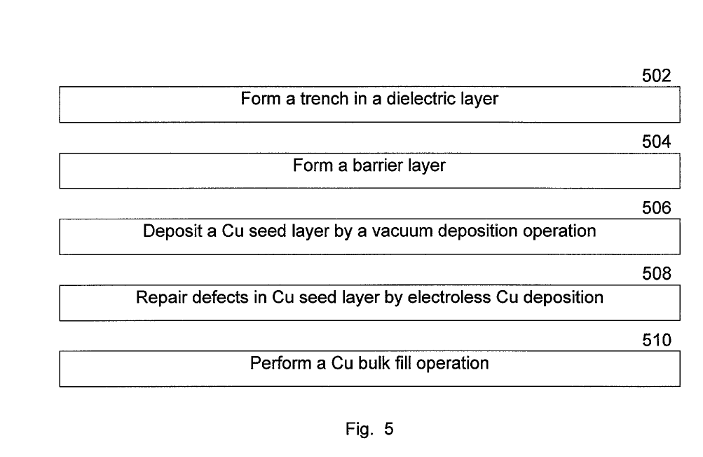

FIG. 2 is a schematic cross-sectional view of a copper damascene structure 200 formed on a partially processed wafer. Damascene structure 200 represents a post-plating, pre-polishing state of fabrication in which an electroless Cu deposition process has been used to repair a seed layer as well as to perform a bulk fill. More particularly, an ILD 102 is patterned to from a trench therein. As shown in FIG. 2, the vertical sidewall surfaces and bottom surface of the trench, and the top surface of ILD 102 are covered with a barrier layer 104. Barrier layer 104 is formed of a material which substantially or completely prevents the diffusion of copper atoms from a subsequently formed copper or copper-alloy layer. A seed layer 105 is formed over barrier layer 104. Copper and cobalt are examples of metals that may be used to form seed layer 105. An electroless deposition of copper is then performed. As further indicated in FIG. 2, a bulk fill copper deposition is performed to complete the trench filling operation. Bulk fill copper 210 covers seed layer 105 both in the trench and over the top surface of ILD 102. In this example, bulk fill copper is formed by an electroless deposition. In fact, the bulk fill operation may be a continuation of the electroless deposition which is used to repair the seed layer.

Illustrative Methods

Embodiments of the present invention include electroless deposition of a thin Cu seed layer on barrier layer to facilitate the electroplating of Cu interconnects. Such a seed layer is typically about 100 angstroms in thickness. The barrier layer may be formed from materials, including but not limited to Ta, TaN, TaSiN, W, WN, WSiN, Ti, TiN, TiSiN and combinations of these materials.

Electroless metal plating is an autocatalytic (non-electrolytic) method of deposition from solution. The electrons required for the metal reduction are supplied by the simultaneous oxidation of a reducing agent on the catalytic surface and reduction of metal ions. Plating is initiated on a catalyzed surface and is sustained by the catalytic nature of the plated metal surface itself. Different components of an electroless process in accordance with the present invention include the catalyzation of electroless Cu deposition and the electroless bath components.

With respect to the catalyzation of an electroless Cu deposition, this reaction takes place on a layer which has the catalytic properties to invoke the initial oxidation reaction of the reducing agent. Cu, Pd, Pt, Ru, Rh, Au, Ag, Co, and Ni are catalytic surfaces for oxidation of a reducing agent. In the illustrative embodiments described herein, Co is used as the catalytic layer. Co can be deposited on the barrier layer by wet or dry methods. Examples of dry deposition methods include CVD, PVD and ALD (atomic layer deposition). Examples of wet deposition methods include Co contact displacement deposition in a solution containing Co ions and acid (such as, but not limited to, HF, HCI, and HNO₃) or bases (such as, but not limited to, KOH, and tetramethylammonium hydroxide (TMAH)) to dissolve oxide on the barrier layer, complexing agents (such as, but not limited to, citric acid, and acetic acid) and reducing agents (such as, but not limited to, hypophosphite, dimethylamine borane (DMAB), and hydrazine). Co is relatively easy to work with, and can also act to improve the electromigration characteristics of the copper interconnect. Such a Co layer is typically less than about 500 angstroms in thickness. In the illustrative embodiments described herein, the Co layer is nominally 100 angstroms thick.

With respect to the electroless bath components, a source of Cu, a reducing agent, a pH buffer, a complexing agent, and a surfactant are used. A simple Cu salt (1-10 g/l) such as copper sulfate, copper chloride or copper nitrate may be used as the source of copper. Formaldehyde, hypophosphite, and glyoxylic acid can be used as reducing agents (2-15 g/l) for an electroless deposition of Cu in accordance with the present invention. Virtually all commercial electroless copper baths utilize formaldehyde as the reducing agent. However, due to environmental, health and safety (EHS) reasons, use of baths containing formaldehyde is not expected to be permissible in semiconductor manufacturing facilities in the future. Therefore, glyoxylic acid is the presently preferred ingredient for use as a reducing agent in connection with embodiments of the present invention.

Electroless Cu baths using above reducing agents described above employ a relatively high pH, usually between 9 and 13, and adjusted generally by potassium hydroxide (KOH) or sodium hydroxide (NaOH). However, in advanced interconnect applications, the use of an alkaline metal-free pH adjuster such as, ammonium hydroxide or tetramethylammonium hydroxide (TMAH) is preferred.

Since copper salts are insoluble in alkaline pH, a complexing or chelating agent is necessary. Ethylenediamine tetra-acetic acid (EDTA), tartrate salt (e.g., Rochelle salt, ammonium tartrate) and alkanol amines such as quadrol (N,N,N′,N′ tetrakis(2-hydroxypropyl)ethylenediamine) or related compounds are usually employed in the range 10-75 g/l. Tartrates have the advantage that they are particularly suitable for low deposition rates, near room temperature applications, and are easily waste-treatable.

A surfactant such as polyethylene glycol (5-100 ppm) may be used as a wetting agent. In addition to polyethylene glycol, surfactants such as, but not limited to, polypropylene glycol, Triton X-100 (t-octylphenoxypolyethoxyethanol) available from Sigma-Aldrich of St. Louis, Mo., and Rhodafac RE 610 available from Rhone-Poulenc of France, can be used.

A particular example of a high temperature bath (referred to herein as Bath A) in accordance with the present invention includes 3 g/l CuSO₄·5H₂O, 6 g/l glyoxylic acid, 20 g/l ammonium tartrate, an amount of KOH or TMAH needed to adjust the pH of Bath A to 12.3, and 10 ppm polyethylene glycol (PEG). The bath is operated at 70° C. in this example, however a high temperature bath such as the one described here may be operated within a range of temperatures between 40° C. and 90° C.

A particular example of an ambient temperature bath (referred to herein as Bath B) in accordance with the present invention includes 3 g/l CuSO₄·5H₂O, 6 g/l glyoxylic acid, 20 g/l Rochelle salt, an amount of TMAH to adjust the pH of Bath B to 12.3, and 100 ppm PEG. Evaporation of TMAH at room temperature is significantly less than at the elevated temperature of Bath A, therefore Bath B is more stable over a longer period than Bath A.

It will be recognized by those of ordinary skill in this field that the ingredients which are combined to form a plating bath may, when combined, form various mixture and reaction products, may ionize or dissociate, or may form complexes.

For a given bath, the grain size and surface roughness increases with increasing deposition time (which can be viewed alternatively in terms of thickness); however for thickness of the order of 100 angstroms, a smooth surface is obtained. Conformality of electroless Cu deposition has been demonstrated by the inventors on narrow trenches (e.g., 0.1 um openings in a dielectric layer).

An electroless Cu bath can be employed in the fabrication of Cu interconnect in several different ways, including for example, the formation of a seed layer/shunt layer, seed layer repair, and bulk Cu deposition for interconnect lines. In a first use, a Cu seed layer can be deposited on a thin catalytic Co layer which itself can be deposited by electroless or vacuum methods. A conformal and continuous deposition of the Cu seed layer enables subsequent electroplating of void-free Cu interconnects. The underlying Co layer acts as an electrical shunt layer for the completed interconnect line, thereby improving the electromigration properties to the Cu interconnect. A second use is to repair defects in the Cu seed layers by the electroless deposition of a thin layer of Cu. Such defects occur in seed layers that have been deposited by vacuum processes. In this case there is no need for an additional catalytic surface (e.g., a Co catalytic layer). A third use is forming the bulk of the Cu interconnect lines by filling trenches and vias through a prolonged electroless deposition of Cu. Compared to an electrolytic process in which the non-uniformity of current distribution on the wafer leads to non-uniform Cu deposition, an electroless process provides better uniformity of deposition. The Co layer described above allows fabrication of Cu interconnects with improved electromigration properties.

Conclusion

Embodiments of the present invention provide electroless deposition of Cu seed layers useful for the formation, by damascene processing, of electrically conductive interconnect lines on integrated circuits. These interconnect lines are typically formed from copper and copper alloys.

An advantage of some embodiments of the present invention is that an electroless Cu plating bath can be made with environmentally friendly ingredients. In particular, formaldehyde is not a required ingredient of electroless Cu plating baths in accordance with the present invention.

A further advantage of some embodiments of the present invention is that the Co/Cu seed layer provides improvement in electromigration properties of the copper interconnect.

A still further advantage of some embodiments of the present invention is that better uniformity of the thickness of the deposited materials is obtained.

It will be apparent to those skilled in the art that a number of variations or modifications may be made to the illustrative embodiments described above. For example, various combinations of copper sources, pH buffers, pH targets, complexing agents, and other ingredients for the electroless plating baths described above, as well as plating bath temperatures may be used within the scope of the present invention.

Other modifications from the specifically described apparatus, materials and processes will be apparent to those skilled in the art and having the benefit of this disclosure. Accordingly, it is intended that all such modifications and alterations be considered as within the spirit and scope of the invention as defined by the subjoined claims.

What is claimed is:

1. A method of forming copper interconnect, comprising:
forming a trench in a dielectric layer disposed on a substrate, the trench and the dielectric layer having exposed surfaces;
forming a barrier layer over the exposed surfaces;
forming a catalytic layer over the barrier layer; and
performing an electroless deposition of a Cu seed layer over the catalytic layer.

2. The method of claim 1, further comprising performing a Cu bulk fill operation.

3. The method of claim 2, wherein the barrier layer comprises a material selected from the group consisting of Ta, TaN, TaSiN, W, WN, WSiN, Ti, TiN, TiSiN and combinations of these materials.

4. The method of claim 3, wherein the catalytic layer comprises a material selected from the group consisting of Cu, Pd, Pt, Ru, Rh, Au, Ag, Co, and Ni.

5. The method of claim 1, wherein forming the catalytic layer comprises depositing Co.

6. The method of claim 4, wherein the performing an electroless Cu plating operation comprises immersing the substrate into an electroless plating bath comprising a copper source, a reducing agent, a pH buffer, a complexing agent, and a surfactant.

7. The method of claim 6, further comprising the maintaining the electroless plating bath at a temperature between 40° C. and 90° C., the reducing agent is selected from the group consisting of formaldehyde, hypophosphite, and glyoxylic acid; the pH buffer is selected from the group consisting of ammonium hydroxide and trimethylammonium hydroxide; the complexing agent is selected from the group consisting of ethylenediamine tetra-acetic acid, tartrate salt, and quadrol; and the surfactant is selected from the group consisting of polyethylene glycol, polypropylene glycol, Triton X-100, and Rhodafac RE 610.

8. The method of claim 6, further comprising the maintaining the electroless plating bath at a temperature between 20° C. and 30° C., the reducing agent is selected from the group consisting of formaldehyde, hypophosphite, and glyoxylic acid; the pH buffer is selected from the group consisting of ammonium hydroxide and trimethylammonium hydroxide; the complexing agent is selected from the group consisting of ethylenediamine tetra-acetic acid, tartrate salt, and quadrol; and the surfactant is selected from the group consisting of polyethylene glycol, polypropylene glycol, Triton X-100, and Rhodafac RE 610.

9. The method of claim 7, further comprising removing the excess portion of the bulk copper by chemical mechanical polishing to form individual interconnect lines.

10. The method of claim 8, further comprising removing the excess portion of the bulk copper by chemical mechanical polishing to form individual interconnect lines.

11. A method of repairing a copper seed layer, comprising:
forming a layer on a substrate, the layer being a barrier to the diffusion of copper atoms therethrough;
depositing, over the barrier layer, a copper seed layer by a self-ionizing plasma; and
immersing the substrate in an electroless plating bath;
wherein the electroless plating bath is formed by combining at least CuSO₄·5H₂O, glyoxylic acid, a pH buffer; a complexing agent, and polyethylene glycol.

12. The method of claim 11, wherein the pH buffer is selected from the group consisting of potassium hydroxide and tetramethylammonium hydroxide.

13. The method of claim 12, wherein the complexing agent comprises ethylenediamine tetra-acetic acid.

14. The method of claim 11, wherein the pH buffer comprises trimethylammonium hydroxide and the complexing agent comprises a tartrate salt.

15. The method of claim 13, further comprising maintaining the electroless plating bath at approximately 70° C.

16. The method of claim 14, further comprising maintaining the electroless plating bath at room temperature.

17. A method of forming a copper interconnect line, comprising:
forming a trench in a dielectric layer disposed on a substrate, the trench and the dielectric layer having exposed surfaces;
forming a barrier layer over the exposed surfaces;
forming a catalytic layer over the barrier layer;
performing an electroless deposition of a Cu seed layer over the catalytic layer; and
performing a bulk fill operation to, at least, fill the trenches.

18. The method of claim 17, wherein performing a bulk fill operation comprises immersing the substrate in an electroplating bath and applying a forcing a current.

19. The method of claim 17, wherein performing a bulk fill operation comprises an electroless Cu deposition.

20. The method of claim 19, wherein the electroless Cu deposition is performed in a first plating bath and the first plating bath is also used for repairing the seed layer.

21. The method of claim 19, wherein the electroless Cu deposition is performed in a second plating bath, and the seed layer is repaired in a first plating bath which is different from the second plating bath.

22. The method of claim 21, wherein the catalytic layer comprises Co, and the first plating bath is formed from at least tetramethylammonium hydroxide, glyoxylic acid, and polyethylene glycol.
